(19) United States
(12) Patent Application Publication
(10) Pub. No.: US 2010/0129282 A1
(43) Pub. Date: May 27, 2010

(54) High-purity calcium compounds

(75) Inventors: Bernhard Korner, Rheinberg (DE); Cedric Humbolt, Fontenay-sous-Bois (FR)

Correspondence Address: Solvay;c/o B. Ortego - IAM-NAFTA, 3333 Richmond Avenue, Houston, TX, 77098-3099, US

(73) Assignee: SOLVAY (SOCIETE ANONYME), Brussels (BE)

(21) Appl. No.: 12/594,174

(22) PCT Filed: Apr. 4, 2008
(86) PCT No.: PCT/EP08/54120

§ 371 Date: Sep. 30, 2009

(30) Foreign Application Priority Data
Apr. 5, 2007 (EP) 07105803.6

(51) Int. Cl. C01F 11/18; C01B 33/037

(52) U.S. Cl. 423/348; 423/430

(57) ABSTRACT

A calcium product contains, in dry state, at least 97% by weight of a calcium compound selected from the group consisting of calcium oxide, calcium hydroxide, calcium sulfate (up to 3% by weight, preferably less) and calcium carbonate, and less than or equal to 4.2 ppm by weight of phosphorus with respect to calcium content and less than or equal to 1.4 ppm by weight of boron with respect to calcium content.

The present application claims the benefit of the European patent application 07105803.6 filed on Apr. 5, 2007, herein incorporated by reference.

### TECHNICAL FIELD

The present invention generally relates to high-purity calcium compounds, in particular calcium carbonate and calcium oxide.

### BACKGROUND ART

There is a demand for highly pure calcium compounds in various industries, e.g. the pharmaceutical, the food and the solar cell industry. As will briefly be discussed hereinafter, the latter may be interested, in particular, in highly pure calcium oxide.

Photovoltaic systems cover today only a small part of the worldwide demand of electrical power. Nevertheless, with the increasing demand for renewable energy resources, the photovoltaic market has experienced remarkable growth in the recent years, and, according to market analysts, the growth will still increase over the coming years. Today, the majority of solar cells are based on silicon and it is assumed that crystalline photovoltaic technology will dominate the market for the next decade. Due to high requirements regarding purity of silicon for the solar cell industry, the main sources of solar grade silicon cannot be used. The growth of the photovoltaic market naturally has an important impact on the availability and consequently the market price of solar grade silicon. For solar grade silicon, there are strict requirements to the content of boron and phosphorus. According to U.S. 2004/0238372 A1, solar grade silicon should have a maximum allowable content of boron and phosphorus of 1 ppm (parts per million in terms of weight).

As an alternative source of solar grade silicon, it has been proposed to refine metallurgical grade silicon to achieve a degree of purity that complies with the requirements of the photovoltaic industry. A usual treatment to remove boron from molten silicon is the use of a calcium-silicate based slag. In order not to increase the phosphorus content of silicon during slag treatment, the phosphorus content of the calcium-silicate based slag should be as low as possible. It is therefore necessary to use a slag having a low boron and phosphorus content. A method for the treatment of such metallurgical grade silicon is e.g. disclosed in

U.S. 2005/0172757 A1. The cited document proposes to use a calcium-silicate based slag containing less than 3 ppmw phosphorus. It is further mentioned that it is difficult to find a calcium oxide source with sufficiently low phosphorus content to prepare the calcium-silicate slag. The document discloses, in particular, a method for producing a low phosphorus calcium-silicate based slag by treating it with molten ferrosilicon alloy in a vessel.

Calcium oxide is conventionally obtained from the calcination of limestone. However, naturally occurring calcium carbonate—and thus the quicklime burnt from it—is normally contaminated with too high amounts of phosphorus and boron. The present invention therefore seeks to use calcium carbonate from synthesis.

A method for producing highly pure calcium carbonate powders, e.g. for application in pharmaceutical or food industry, is disclosed in EP 0 499 666 A1. The document proposes to carry out the precipitation of calcium carbonate from aqueous solutions in such a way that the formed CaCO₃ remains substantially free of impurities even if the mixed solutions contain a considerable amount of other ions. To provide calcium ions, the document suggests, in particular, the use of treated and cleaned mother liquor of the ammonia-soda process (also known as the Solvay soda process). The precipitation is achieved at temperatures between 20 and 50° C. under weakly basic conditions. The so-formed precipitate mainly consists of vaterite, which is maintained in presence of an aqueous phase at temperatures between 15 and 80° C. until most of the vaterite has been converted into calcite. It is worthwhile noting that the obtained precipitate has only been analysed with regard to impurities of Cl, N, SO₃ and Na.

### TECHNICAL PROBLEM

It is an object of the present invention to provide highly pure calcium carbonate or calcium oxide.

This object is achieved by a calcium product as claimed in claim 1.

### GENERAL DESCRIPTION OF THE INVENTION

It is proposed a highly pure calcium product, the terms “highly pure” meaning, in the present context, that the calcium product contains, in dry state (i.e. when dry), at least 97%, preferably at least 98%, more preferably at least 99% by weight (more preferably at least 99.5% and still more preferably at least 99.9%) of a calcium compound chosen from calcium carbonate, calcium hydroxide and/or calcium oxide (up to 3% by weight of calcium sulphate may be present, preferably less), and according to an important aspect of the invention, that the calcium product contains, in dry state, less than or equal to 1.4 ppm by weight (hereinafter abbreviated as ppmw) of boron with respect to calcium content and less than or equal to 4.2 ppmw of phosphorus with respect to calcium content. The boron content with respect to calcium content of the dry product more preferably amounts to less than or equal to 1.1 ppmw, still more preferably to less than or equal to 0.7 ppmw and most preferably to less than or equal to 0.4 ppmw—which corresponds to the current quantification limit for boron content using Optical Emission Spectrometry-Inductively Coupled Plasma (OES-ICP). The phosphorus content with respect to calcium content of the dry product more preferably amounts to less than or equal to 2.8 ppmw, still more preferably to less than or equal to 2.1 ppmw, still more preferably to less than or equal to 1.4 ppmw, and most preferably to less than or equal to 1.1 ppmw (current quantification limit for phosphorus by OES-ICP). It is understood that, as used herein, “dry state” designates the state of a product when this is substantially dry, i.e. substantially free of liquid (e.g. water). The dry state can be reached by drying the product at about 105° C. until the weight thereof remains constant. It should be noted that in case the calcium product contains CaO, the presence of water causes the formation of calcium hydroxide. In this case, drying at the indicated temperature does of course not lead to the initial CaO, which requires temperatures of at least 400-500° C. to form from Ca(OH)₂.

Preferably, the heavy metal (Fe, Cu, Ni, Pb, Cr, Cd, etc.) content of the calcium product as defined above does not exceed 0.1% by weight, more preferably, it does not exceed 0.01% by weight, still more preferably, it does not exceed 0.001% by weight. Usually, the calcium product contains, in the dry state, less than 3% by weight of calcium sulphate. Calcium sulfate may result from residual sulphate ions contained in the reactants. Advantageous, the calcium product also contains, in the dry state, less than 2.5%, preferably less than 2%, more preferably less than 1% and most preferably less than 0.5% by weight of calcium sulphate.

According to a first preferred embodiment of the invention, the mentioned calcium compound comprises, in the dry state, at least 97% (preferably at least 98%, more preferably at least 99%, still more preferably 99.5% and most preferably at least 99.9%) by weight of calcium carbonate. In this case, the calcium product will be referred to as calcium carbonate product. It will be appreciated that such a calcium carbonate product is suited, in particular, for use in the food industry and/or the pharmaceutical industry. Advantageously, at least 50% of the calcium carbonate product is in the calcite crystal form.

According to second preferred embodiment of the invention, the calcium compound comprises, in the dry state, at least 97% (preferably at least 98%, more preferably at least 99%, still more preferably 99.5% and most preferably at least 99.9%) by weight of calcium oxide. The calcium product is then referred to as calcium oxide product. The calcium oxide product may be obtained from the calcium carbonate product by calcination. It should be noted that a calcium oxide product as set forth herein is suited, in particular, for use in the purification of metallurgical silicon since it has increased efficiency with respect to most calcium oxide burnt from natural limestone.

The present invention is further concerned with processes for producing high-purity calcium compounds as specified above. Such processes may include, in particular, the precipitation of calcium carbonate from a solution containing carbonate and/or hydrogenocarbonate and calcium chloride, and/or the calcination of calcium carbonate into calcium oxide.

For the production of a highly pure calcium carbonate product with low boron content by precipitation, there is normally the problem that boron present in the solution co-precipitates with the calcium carbonate and is trapped in the formed calcium carbonate crystals. It further seems that boron co-precipitates all along the precipitation of calcium carbonate, so that it is normally not possible (without taking any special measures) to reduce the boron content of the solution by precipitating, in a first step, only a part of the calcium carbonate and an important part of boron, thus leaving behind a solution with substantially reduced boron content, which would then be used in a second step for precipitating highly pure calcium carbonate.

It is worthwhile noting that as a source of calcium ions, one may advantageously use the mother liquor of a soda ash plant that uses the ammonia-soda process. According to a highly preferred embodiment of the invention, calcium ions are thus provided in an aqueous solution that comprises or consists of clarified mother liquor from a soda ash plant. This mother liquor is referred to hereinafter as “liquid DS”. Clarification of the mother liquor can e.g. be achieved by sedimentation and/or decantation and/or filtration. The clarification of the mother liquor can be aided by pH adjustment (into the acid or the basic range), the addition of flocculation agents (e.g. polyacrylate, polyaluminiumacrylate, etc.). As will be appreciated, the phosphorus content of clarified liquid DS normally lies below the limit of 4.2 ppmw with respect to calcium content (e.g. at about 2.5 ppmw with respect to Ca content) so that the use of liquid DS is uncritical with respect to phosphorus contamination of the precipitate. However, one would normally not qualify liquid DS as “boron-free”: depending on the origin of the raw materials intervening in the ammonia-soda process, the boron content of the mother liquor may vary. Typical values are 5 to 20 ppmw with respect to calcium content for the clarified liquid DS, in some production sites, however, boron content may reach more than 100 ppmw with respect to calcium content. Those skilled will appreciate that the present process is especially suited for obtaining calcium carbonate from liquid DS having a boron content of about 3 to 20 ppmw with respect to calcium content.

It may therefore be necessary, in particular when liquid DS is used (but not only in this case), to take measures to avoid co-precipitation of boron with calcium carbonate. These measures may include a specific selection of the precipitation parameters, removal of boron by ion exchange resins from the starting materials, forming boron complexes (e.g. by addition of saccharides, polysaccharides and/or derivatives of saccharides and/or polysaccharides) or any combination of these measures.

It has been surprisingly found that by carrying out the precipitation under particular conditions, boron present in the solution co-precipitates to a substantially lesser amount than one would have expected from experiments carried out with similar boron concentrations under different conditions.

According to a first embodiment of a precipitation process, a united solution containing carbonate and calcium chloride is provided by bringing together a first solution containing calcium chloride and a second solution containing carbonate. For the purposes of the present invention, a “solution containing carbonate” should be understood as encompassing a solution containing a carbonate salt (e.g. Na₂CO₃, (NH₄)₂CO₃ or the like) or a hydrogenocarbonate salt (e.g. NaHCO₃, NH₄HCO₃, or the like). The calcium chloride concentration of the first solution (hereinafter labeled “X” mol/l) amounting to between 0.1 and 1.2 mol/l (i.e. 0.1≦X≦1.2) and the carbonate concentration of the second solution (hereinafter labeled “Y” mol/l) amounting to between 0.1 and 2.5 mol/l (i.e. 0.1≦Y≦2.5), and the concentrations being such that the inequality X×Y≦0.7 is fulfilled. Those skilled will be aware that the possible use of HCO₃⁻ may lead, depending on the pH of the solution, to formation of CO₂ gas. A further condition is that the contents in phosphorus and boron of the united solution is below or equal to 4.2 ppmw with respect to calcium content for phosphorus and below or equal to 10 ppm (more preferably 7.5 ppm, still more preferably 5 ppm) by weight with respect to calcium content for boron.

As used herein, the term “united solution” designates here the (theoretical) solution which one would obtain by putting together the first and second solutions containing carbonate and calcium chloride, respectively, under the assumption that no precipitation takes place, i.e. that all ions remain in the solution. In practice, putting together the first and second solutions immediately leads to some precipitation from the actually resulting solution. The precipitation should be carried out at a temperature between about 35 and about 100° C., preferably between 35 and 70° C., more preferably between 40 and 60° C. Thereafter, the precipitated calcium carbonate product is separated from the mother liquor and optionally rinsed (with water containing little boron and phosphorus). If needed the precipitated calcium carbonate may also be dried. It will be appreciated that the process is useful, in particular, if the boron content of the united solution from which one precipitates is higher than 1.4 ppmw with respect to calcium content (e.g. higher than 5 ppmw with respect to calcium content). Advantageously, the product X×Y may be chosen below or equal to 0.65, more preferably below or equal to 0.6, e.g. if purer precipitate is desired. Preferably, bringing together the first and second solution is accompanied and/or followed by stirring.

According to a preferred embodiment of the invention, boron concentration (relative to calcium) and temperature of the formed solution containing carbonate and calcium chloride are taken into account for setting the value of the product X×Y. For instance, if the boron content of the united solution is between 7.5 ppm and 10 ppm with respect to calcium content and the precipitation is carried out at a temperature in the range between 45 and 50° C., the condition on X×Y might be restricted to X×Y≦0.55. With the same boron content, at a temperature between 50 and 60° C., one might prefer X×Y≦0.60. If the boron content of the united solution is between 5 ppm and 7.5 ppm, with respect to calcium content, the conditions on temperature and the product X×Y might be somewhat relaxed with respect to the previous example. In this example, one might require X×Y≦0.60 for the temperature range 45 to 50° C. and/or X×Y≦0.7 for temperatures above 50° C. The second solution containing carbonate may be added into a recipient containing the first solution with the calcium chloride. Preferably, however, the first solution containing calcium chloride is added (e.g. progressively) to the second solution containing carbonate, which has been previously provided in the reaction container. In case of progressive addition of the first solution, this may be achieved (at a substantially constant or a time-varying addition rate) over a time period of preferably 1 minute to 3 hours, more preferably of 10 minutes to 1.5 hours and still more preferably of 30 minutes to 1 hour. Progressively adding the calcium chloride solution to the carbonate solution is especially preferred if boron is primarily contained in the calcium chloride solution, as it may be the case when mother liquor from the ammonia-soda process is used.

According to a first alternative of a second embodiment of the precipitation process, a united solution containing carbonate and calcium chloride is formed by bringing together a solution containing carbonate, and calcium chloride at least partially in solid form. In this case, the carbonate concentration of the solution (hereinafter labeled “Y” mol/l) amounts to less than or equal to 0.7 mol/l (more preferably less than or equal to 0.6 mol/l, still more preferably less than or equal to 0.5 mol/l and even more preferably less than or equal to 0.4 mol/l). The boron content in the united solution is usually below or equal to 10 ppm (more preferably 7.5 ppm and even more preferably 5 ppm) by weight with respect to calcium content and the phosphorus content in the united solution is generally below or equal to 4.2 ppmw with respect to calcium content. The temperature at which the calcium carbonate is precipitated may be chosen in the range from about 35 to about 100° C., preferably between 35 and 70° C. and more preferably between 40 and 60° C. Stirring the formed solution is also considered advantageous for the present embodiment. The precipitate is separated from the mother liquor and optionally any residual liquor is rinsed from the calcium carbonate product after precipitation. If needed or desired, the calcium carbonate product may also be dried.

In a second alternative of the second embodiment, the united solution containing a carbonate and calcium chloride can likewise be formed by bringing together carbonate at least partially in solid form, and a solution containing calcium chloride, the calcium concentration of the solution (hereinafter labeled “X” mol/l) amounting to less than or equal to 0.7 mol/l (more preferably less than or equal to 0.6 mol/l, still more preferably less than or equal to 0.5 mol/l and even more preferably less than or equal to 0.4 mol/l). The boron content in the united solution is usually below or equal to 10 ppm by weight with respect to calcium content and the phosphorus content is in general below or equal to 4.2 ppm by weight with respect to calcium content. As above, the precipitation of calcium carbonate from the formed united solution containing the carbonate and the calcium chloride is effected at a temperature from about 35 to about 100° C., preferably between 35 and 70° C. and more preferably between 40 and 60° C.; followed by the separation of the precipitated calcium carbonate. Optionally, said precipitated calcium carbonate is rinsed and if desired or needed dried. Stirring the formed united solution is also considered advantageous for the present embodiment.

In other words, in both alternatives of the second embodiment, when using the inequality described for the first embodiment, the concentration of the solutions, i.e. the carbonate concentration “Y” in the carbonate containing solution (first alternative), respectively the calcium chloride concentration “X” in the calcium chloride containing solution (second alternative), is chosen such that the product X×Y≦0.7, the “concentration” of the reactant added (at least partially) in solid form being assumed to equal 1 for the purpose of the present invention.

Hence, the advantage of above embodiments of the process of the present invention is the reduced co-precipitation of boron and phosphorus, which can surprisingly be achieved by considering the respective concentrations of the reactants in solution. Therefore, a further advantage of the present invention is the fact that the process parameters can be easily determined from the initial concentration of each reactant, without having to consider effective concentrations at any or all time during combination of the reactants.

In both mentioned embodiments of the precipitation process, the concentrations in carbonate and calcium chloride of the united solution as well as the temperature at which precipitation is carried out are preferably chosen in such a way as to favor formation of calcite crystals rather than vaterite or aragonite. It is currently assumed that boron incorporation into calcite during crystal growth is less efficient than into vaterite or aragonite.

According to a preferred embodiment of the invention, the process for forming a calcium product as disclosed herein comprises precipitation of calcium carbonate from a united solution containing carbonate and calcium chloride that is substantially boron-free and phosphorus-free. For the purposes of the present invention, this means that the united solution in which the precipitation is carried out has a boron content of below or equal to 1.4 ppmw and a phosphorus content of below or equal to 4.2 ppmw with respect to calcium content. The boron content with respect to calcium content more preferably amounts to less than or equal to 1.1 ppmw, still more preferably to less than or equal to 0.7 ppmw and most preferably to less than or equal to 0.4 ppmw. The phosphorus content with respect to calcium content more preferably amounts to less than 2.8 ppmw, still more preferably to less than or equal to 2.1 ppmw, still more preferably to less than or equal to 1.4 ppmw, and most preferably to less than or equal to 1.1 ppmw. The precipitation is carried out by bringing together carbonate and calcium chloride, at least one of which is provided in an aqueous solution. The other reactant may be provided in solid form or also in a solution, which is then mixed with the first solution. To achieve the low boron content, before bringing together the reactants, boron can be removed from the initial solution or solutions by means of an ion exchange resin so that the boron content in the resulting united solution is below or equal to the above-specified limit.

Preferably, the solution to be cleaned with the ion exchange resin has a pH between about 6 and 8, more preferably between 6.2 and 7.2.

According to another preferred embodiment of the invention, the process for forming the calcium product includes the precipitation of calcium carbonate from a solution that is substantially phosphorus-free, i.e. its phosphorus content is below or equal to 4.2 ppmw with respect to calcium content. The phosphorus content with respect to calcium content more preferably amounts to less than 2.8 ppmw, still more preferably to less than or equal to 2.1 ppmw, still more preferably to less than or equal to 1.4 ppmw, and most preferably to less than or equal to 1.1 ppmw. The precipitation is carried out by bringing together carbonate and calcium chloride at least one of which is provided in an aqueous solution. The other reactant may be provided in solid form or also in a solution, which is then mixed with the first solution. Before bringing together the reactants, boron complexes are formed in the solution(s) by addition of one or more saccharides and/or polysaccharides and/or one or more surface-active derivatives of saccharides and/or polysaccharides. The so-formed boron complexes may either inhibit the co-precipitation of boron with the calcium carbonate or enhance the co-precipitation thereof. If the co-precipitation is inhibited, the precipitate will be less contaminated with boron. If the coprecipitation is enhanced, one may carry out the precipitation of calcium carbonate in at least two steps. In a first step, only a part of the calcium carbonate is precipitated but due to the increased co-precipitation of boron the remaining solution thereafter exhibits reduced boron content. In a second step, the rest of the calcium carbonate is precipitated. The calcium carbonate obtained in the second step then has substantially reduced boron contamination compared to the precipitate obtained in the first step.

Turning now to the production of a calcium oxide product as set forth herein, it is understood that such a calcium oxide product may be obtained from calcining a calcium carbonate product containing, in dry state, at least 97% preferably at least 98%, more preferably at least 99% by weight (more preferably at least 99.5% and still more preferably at least 99.9%) of a calcium carbonate, less than or equal to 2.8 ppmw, preferably less than or equal to 2.1 ppmw, more preferably less than or equal to 1.4 ppmw, and most preferably less than or equal to 1.1 ppmw of phosphorus with respect to calcium content and less than or equal to 1.4 ppmw, preferably less than or equal to 1.1 ppmw, more preferably less than or equal to 0.7 ppmw and most preferably less than or equal to 0.4 ppmw of boron with respect to calcium content. Tests have indeed indicated that the boron content with respect to the calcium content remains essentially the same during the calcination.

Further to the above calcium carbonate and calcium oxide products, it is clear to the skilled person that other calcium products with the above very low boron and phosphorus contents may be obtained using generally known techniques and process steps. For example, further calcium products according to the invention, such as calcium hydroxide with very low boron and phosphorus contents may be obtained by slaking, i.e. by contacting calcium oxide with water.

Hence, in a further embodiment, the above calcium oxide product is contacted with water by taking care not to introduce further amounts of boron and/or phosphorus, preferably by using distillated, deionised and/or demineralized water, or even steam or water vapor.

### BRIEF DESCRIPTION OF THE DRAWINGS

Further details and advantages of the present invention will be apparent from the following detailed description of not limiting embodiments with reference to the attached drawing, wherein:

FIG. 1 is a schematic flow diagram of the production of calcium oxide from the liquors intervening in the ammonia-soda process.

### DESCRIPTION OF PREFERRED EMBODIMENTS

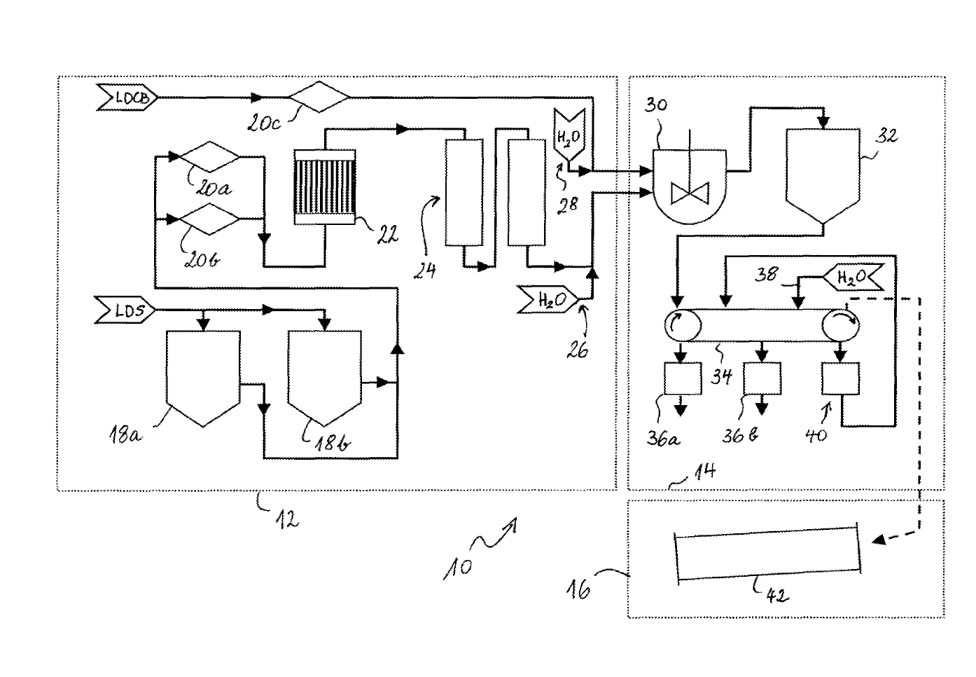

FIG. 1 illustrates a process 10 for the production of a highly pure calcium oxide product from liquors used in the ammonia-soda process. The preparation of the starting materials is shown in box 12, the precipitation and the subsequent cleaning of calcium carbonate in box 14 and the calcination of the obtained calcium carbonate into calcium oxide in box 16.

As starting materials are used in this case the mother liquor of the soda ash plant, referenced in the drawing as LDS, containing dissolved calcium chloride, and liquor containing Na₂CO₃ (and possibly NaHCO₃), referenced in the drawing as LDCB (also originating from the soda ash plant). These solutions have the inherent advantage of being substantially phosphorus-free, so that co-precipitation of phosphorus is not an issue.

Prior to the precipitation, the mother liquor is clarified from solid suspended matter by sedimentation, decantation and filtration. Sedimentation and decantation are achieved in separators or decanters 18a and 18b and followed by filtration at filters 20a and 20b. The clarification may be carried out with addition of HCl or NaOH for pH adjustment, and addition of flocculation agents.

Mother liquor is available in a soda ash plant normally at temperatures between 75 and 80° C. The desired temperature of 35 to 70° C. at the precipitation may therefore be obtained by cooling the mother liquor using a heat exchanger 22. It should be noted, that if for some reason the temperature of the mother liquor were below the desired temperature for the precipitation, one could of course use heat exchanger 22 for heating.

At reference numeral 24, the mother liquor LDS undergoes a treatment with ion exchange resins to lower the boron content of the liquor to a desired value. The treatment of the liquor with ion exchangers may be preceded, if necessary, by an adjustment of the pH of the liquor, which preferably is in the range from 6.2 to 7.2 for the ion exchange treatment. Since the pH of the mother liquor typically amounts to about 10, pH adjustment to the desired range can be achieved by addition of HCl. The ion exchange treatment step can be bypassed if the boron content of the clarified LDS liquor is below a certain limit depending on the parameters of the precipitation. Possible ion exchange resins that may be used are, for instance, Amberlite™ IRA743 (Rohm and Haas), Lewatit™ MK 51 (Sybron Chemicals Inc.), XUS-43594.00 and Dowex™ 21K XLT (Dow Chemical Company).

It should be noted that the concentration of heavy metals like lead, iron, copper, nickel and so forth may, in addition, be lowered by adjusting the pH-value of the LDS liquor or, if necessary using flocculation agent or a treatment step with ion exchangers.

The mother liquor as provided by the soda ash plant typically has a calcium concentration of about 1 mol/l (e.g. 0.8-1.2 mol/l), which depends on current production parameters and possible dilution of the liquor by other process streams. If lower concentration of calcium is desired, the mother liquor may be diluted with water. This is illustrated at 26, but it is understood that the dilution of the LDS liquor could also be done before the treatment with ion exchange resins, the heat exchanger 22 or the filters 20a and 20b.

As source of carbonate ions, several possibilities can be readily contemplated. Possible sources are Na₂CO₃ or NaHCO₃ in solid form or as a solution. Another option would be to use solutions of (NH₄)₂CO₃ or NH₄HCO₃. The latter option however implies, in a practical implementation, that ammonia is recovered from the solution after precipitation. A convenient choice may be to use the Na₂CO₃-containing liquor LDCB, which is available at the soda ash plant. This option is also illustrated in the drawing. LDCB liquor from a soda ash plant has the advantage that it contains no significant amounts of boron in comparison to the LDS liquor. Prior to entering the precipitation stage, the LDCB liquor is filtered (in filter 20c). Of course, other clarification steps, such as sedimentation and/or decantation and/or pH adjustment and/or temperature adjustment) could also be carried out before or after the filtration. If deemed necessary, water may be added at 28 (or before) to adjust the concentration of carbonate and hydrogenocarbonate ions in the solution.

The precipitation stage is now discussed with reference to box 14. The solutions containing carbonate and calcium ions, respectively, are mixed in a recipient 30. The parameters of the precipitation (temperature, concentrations, pH, relative amounts of substance of calcium ions and carbonate, time of addition, retention time etc.) may be chosen according to the boron content of the solutions that enter the precipitation stage. If, for instance, the total boron content of the solutions with respect to calcium content has been brought below the limit specified for the calcium carbonate product or the calcium oxide product (e.g. by the ion exchange resin treatment), any choice of precipitation parameters brings the desired result even if all boron co-precipitated. If, however, the residual boron content with respect to calcium content is above the specified limit, the choice of precipitation parameters may be essential.

For the purposes of illustration, we will rely upon examples, in which the solution containing the calcium chloride was LDS liquor having a boron content of about 7.5 ppmw with respect to calcium content. The carbonate source, on the other hand, provided only negligible amounts of boron in the examples. Assuming, hypothetically, that boron co-precipitated in its entirety, the resulting calcium carbonate product would exhibit a boron concentration of 3 ppmw (which corresponds to 7.5 ppmw with respect to calcium content), which is therefore the theoretical maximum concentration of boron in the calcium carbonate product for the given boron content of the LDS liquor. Calcium oxide burnt from this hypothetical calcium carbonate product would have a boron content of about 5.3 ppmw (7.5 ppmw with respect to calcium content). We will hereinafter express resulting boron concentrations in the precipitate as a percentage of the theoretical maximum concentration. Supposing a calcium oxide product with boron content of below or equal to 1 ppmw (corresponds to 1.4 ppmw with respect to calcium content) is required, co-precipitation of boron should not exceed 19% of the theoretical maximum value.

Experiments have shown that operating with LDS liquor at [Ca²⁺]≈1 mol/l and a Na₂CO₃ solution at [CO₃²⁻]≈1 mol/l leads to a highly viscous gel phase, which can only be destroyed by massive input of mechanical energy or very long retention times (stability over more than 24 hours has been observed). This may cause severe problems in stirred batches or static mixers. Retarded addition of one reactant (addition during up to 30 minutes at a substantially constant addition rate), adjusting the temperature (up to 75° C.) or adjusting pH of LDS liquor did not cure the problem. It was furthermore observed that in such a gel phase regime, the precipitation of boron was almost complete when the two solutions were brought together in a very short time (≦5 s): about 100% of the theoretical maximum concentration in the precipitate. When the precipitation was carried out at an elevated temperature (75° C.) and one of the solutions was progressively added to the other (during 30 minutes), the boron concentration still amounted to 33%.

Keeping the initial Ca²⁺ concentration at 1 mol/l and the initial carbonate concentration at 0.5 mol/l, temperature influence was assessed in the range from 40 to 70° C. in nearly stoichiometric batch experiments. This yielded relative boron concentrations between 43% (at 40° C.) and 7% (at 70° C.). In the temperature range from 40 to 50° C., it was found that the boron concentration decreased steeply from above 40 to 13%. Bad mixing or almost instantaneous addition (duration≦5 s) of the solutions seemed to deteriorate the results by about 3 to 5%.

The influence of the initial CO₃²⁻ has been evaluated for different fixed temperatures ([Ca²⁺] remained at 1 mol/l). At 60° C., [CO₃²⁻]=0.5 mol/l yielded a relative boron concentration in the precipitate of 7%, [CO₃²⁻]=0.625 mol/l a relative boron concentration of 7%, [CO₃²⁻]=0,833 mol/l a relative boron concentration of 27%. At 50° C. and [CO₃²⁻]=0.5 mol/l yielded a relative boron concentration of 10% and [CO₃²⁻]=0.625 mol/l a relative boron concentration of 20%. Other tests seem to indicate that similar results are obtained if the numerical values of the initial concentrations of Ca²⁺ and CO₃²⁻ are switched.

Still referring to the precipitation stage, it is worthwhile noting that continuous precipitation may serve as an alternative to the above-mentioned batch precipitation. A continuous precipitation stage might comprise one or more than one mixers (e.g. static mixers) in which one of the reactants is fed to the other reactant that acts as the carrier flow. A preferred embodiment of a continuous precipitation stage features at least two, advantageously three sequential static mixers, through which flows the carrier flow of clarified LDS liquor or a carbonate containing solution. At each mixer stage a part of the necessary amount of reactant may be added to the carrier flow. The precipitation stage may further comprise flow sections downstream each mixer to assure a certain resting time after the mixing stages.

Whether continuous precipitation or batch precipitation should be preferred may depend on the target boron concentration in the precipitate and the concentration of boron with respect to calcium content in the liquor in which the precipitation is achieved. If prior removal or complexing of boron is feasible at a reasonable expense, a continuous precipitation stage might be preferred. If, however, prior removal or complexing of boron is not feasible or too cost-intensive, one might prefer to rely upon precipitation in batch reactors.

An alternative to using LDCB liquor as shown in the drawing, one may use raw sodium bicarbonate (e.g. as a solid, a wet cake or a suspension), which is readily available at a soda ash plant operating according to the ammonia-soda process. In tests, bicarbonate was added in stoichiometric amounts to clarified LDS liquor ([Ca²⁺]≈0.4 mol/l, boron content of about 7.5 ppmw with respect to calcium content), which lead to a precipitate containing 7% of the theoretical maximum amount of boron (at a temperature of 50 and 60° C.). Above 60° C., the reaction exhibited a somewhat vigorous behavior (foaming). Using bicarbonate implies that care should be taken to remove CO₂ from the solution after reaction (by a temperature rise and/or stripping and/or backflush of filtrate to reaction vessel), in other words, to reuse or destruct CaHCO₃, respectively. Generated CO₂ is preferably reused (e.g. in the soda ash plant).

Another alternative is to use soda ash as a solid, a wet cake or in suspension. This might reduce costs if otherwise a separate dissolution stage would be necessary. The use of bicarbonate, however, is considered advantageous for the reason that one saves the step of calcining the sodium bicarbonate into soda ash and that during the precipitation reaction, fresh surfaces generate continuously.

In all of the above-described precipitation reactions, one may provide for a resting time after the reaction. If this is done at suitable temperatures, this may also increase the amount of calcite crystals in the precipitate to the detriment of vaterite and/or aragonite crystals.

Turning back to FIG. 1, the formed precipitate is separated from the solution in a separator or decanter 32. The wet cake of calcium carbonate product is then fed to a filter unit (shown in FIG. 1 as a band conveyor filter 34, the filter unit could include, additionally or alternatively a rotary filter, or any other suitable filter) were residual liquor is washed from the precipitate. Washing water is evacuated at 36a and 36b. Fresh washing water is added at 38. As indicated at 40, used washing water collected near the end point of conveyor belt 34 is reused to wash the precipitate at first time. At the end of conveyor belt 34, a wet calcium carbonate product is obtained. A washing rate of about 5 to about 10 (depending on the grain sizes of the product and the chloride concentration of the mother liquor) could be sufficient to reach a chloride content of below or equal to 100 ppmw with respect to the dried product. It has further been noted that washing the calcite form of calcium carbonate to a low chloride content is easier than for the vaterite and aragonite forms.

The resulting calcium carbonate product may be calcined into calcium oxide. The calcination may be carried out starting with wet calcium carbonate. If the calcination is carried out on the same site as the precipitation and the rinsing of the precipitate, complete drying of the precipitate is, therefore, not necessary in all cases. If calcination is to carried out in a remote site, then it may be advantageous to completely dry the calcium carbonate, e.g. for saving transport costs.

Calcination is schematically shown in box 16. The calcium carbonate product is fed to a rotary kiln 42, in which calcination is carried out at suitable temperatures and for time sufficient to achieve the desired conversion rate of CaCO₃ into CaO.

CO₂ released during calcination of calcium carbonate is preferably collected and reused (e.g. in a soda ash plant, if this is on the same site). Preferably, filters are used to prevent fine particles from reaching the atmosphere.

### EXAMPLES

### Example 1

Two m³ of an aqueous solution of sodium carbonate (in a concentration “Y” of 0.45 mol/l) is stirred at 50° C. (two stage blade mixer, 800 rpm) in a thermostatised agitated vessel (5 m³). Boron or phosphorus contents in this solution are below their respective quantification limit (ICP-OES). A stoechiometric amount of an aqueous calcium chloride solution (concentration “X” of 0.89 mol/l), which has also been thermodstatised to 50° C. is added to this stirred solution. The boron contents in this solution amounts 8.4 ppm (by weight) with respect to calcium content. The phosphorus contents in this solution is below the quantification limit (ICP-OES). The product X×Y is in this case 0.40 (i.e. 0.89×0.45). The addition is done over a period of 45 min, followed by additional 15 min of stirring. The resulting dispersion is passed over a band filter, the mother liquor is filtered off and the filter cake is washed with deionised water in a countercurrent process step (washing rate 8 with respect to the dry solids). The wet filter cake is dried in a drying chamber at 105° C. The resulting product contains more than 99.5% of calcium carbonate, >90% of which is in calcitic form. The boron contents, as well as the phosphorus contents of the product are below their respective quantification limits (ICP-OES) of 0.4 ppm (by weight), resp. 1.1 ppm (by weight) with respect to the calcium content of the product. The residual chloride contents, with respect to the product, is 50 ppm (by weight).

### Example 2

One m³ of an aqueous solution of calcium chloride (in a concentration of 0.89 mol/l) is stirred at 40° C. (two stage blade mixer, 1000 rpm) in a thermostatised agitated vessel (5 m³). One m³ of deionised water is added thereto and the resulting concentration “X” is 0.445 mol/l. The boron contents in this solution is 8.4 ppm (by weight) with respect to calcium. A stoechiometric amount of solid sodium carbonate (Y=1) is dispersed within 5 minutes in the continuously stirred liquid phase. The product X×Y is in this case 0.445 (i.e. 0.445×1).The boron and phosphorus contents in the solid sodium carbonate are below their respective quantification limit (ICP-OES). The stirring is continued for 3 h. The resulting dispersion is passed over a band filter, the mother liquor is filtered off and the filter cake is washed with deionised water in a countercurrent process step (washing rate 10 with respect to the dry solids). The wet filter cake is dried in a drying chamber at 105° C.

The resulting product contains more than 99.5% of calcium carbonate, >95% of which is in calcitic form. The boron contents, as well as the phosphorus contents of the product are below their respective quantification limits (ICP-OES) of 0.4 ppm (by weight), resp. 1.1 ppm (by weight) with respect to the calcium content of the product. The residual chloride contents, with respect to the product, is 30 ppm (by weight).

1. A calcium product, containing in the dry state at least 97% by weight of at least one calcium compound selected from the group consisting of calcium oxide, calcium hydroxide, and calcium carbonate, wherein an amount of calcium sulfate does not exceed, in the dry state, 3% of the weight of said calcium product, and wherein said calcium product contains, in dry state, less than or equal to 0.7 ppm by weight of boron with respect to calcium content and less than or equal to 4.2 ppm by weight of phosphorus with respect to calcium content.

2. (canceled)

3. The calcium product according to claim 1, wherein said calcium compound comprises at least 97% by weight of calcium carbonate, in the dry state.

4. The calcium product according to claim 3, wherein said calcium carbonate comprises more than 50% by weight of calcite.

5. The calcium product as claimed in according to claim 1, wherein said calcium compound comprises at least 97% by weight of calcium oxide, in the dry state.

6. (canceled)

7. A process for producing the calcium product according to claim 1, comprising the steps of: forming a united solution containing a carbonate and calcium chloride by bringing together a first solution containing calcium chloride and a second solution containing a carbonate, said first solution having a calcium concentration of X mol/l, said second solution having a carbonate concentration of Y mol/l, wherein X is comprised in the range of from 0.1 to 1.2 and Y is comprised in the range of from 0.1 to 2.5, such that X×Y≦0.7, the united solution having a boron content of below or equal to 10 ppm by weight with respect to calcium content and a phosphorus content of below or equal to 4.2 ppm by weight with respect to calcium content; precipitating calcium carbonate from said united solution containing the carbonate and the calcium chloride at a temperature from 35 to 100° C.; separating the precipitated calcium carbonate from the mother liquor; optionally rinsing said precipitated calcium carbonate; and optionally drying said precipitated calcium carbonate.

8. The process according to claim 7, wherein said first solution containing calcium chloride is added to said second solution containing a carbonate.

9. A process for producing the calcium product according to claim 1, comprising the steps of: forming a united solution containing a carbonate and calcium chloride by bringing together carbonate and calcium chloride, either one being provided at least partially in solid form and the other being provided in solution, which solution has a carbonate, respectively calcium, concentration of less than or equal to 0.7 mol/l, the united solution having a boron content of below or equal to 10 ppm by weight with respect to calcium content and a phosphorus content of below or equal to 4.2 ppm by weight with respect to calcium content; precipitating calcium carbonate from the formed united solution containing the carbonate and the calcium chloride at a temperature from 35 to 100° C.; separating the precipitated calcium carbonate from the mother liquor; optionally rinsing said precipitated calcium carbonate; and optionally drying said precipitated calcium carbonate.

10. The process according to claim 7, wherein the concentrations in carbonate and calcium chloride of said united solution containing carbonate and calcium chloride as well as the temperature at which precipitation is carried out are chosen in such a way as to favor formation of calcite crystals.

11. A process for producing the calcium product according to claim 1, comprising the steps of: precipitating calcium carbonate from a united solution containing a carbonate and calcium chloride by bringing together the carbonate and the calcium chloride, at least one of said carbonate and calcium chloride being provided in an aqueous solution, wherein, prior to said bringing together, boron is removed from said aqueous solution by means of ion exchange resin in such a way that a boron content of below or equal to 1.4 ppm by weight with respect to calcium content is achieved after said bringing together and wherein the formed united solution containing the carbonate and the calcium chloride has a phosphorus content of below or equal to 4.2 ppm by weight with respect to calcium content.

12. A process for producing the calcium product according to claim 1, comprising the steps of: precipitating calcium carbonate from a united solution containing a carbonate and calcium chloride by bringing together the carbonate and the calcium chloride, at least one of said carbonate and calcium chloride being provided in an aqueous solution, wherein, prior to said bringing together, boron complexes are formed in said aqueous solution by addition of saccharide and/or polysaccharide and/or a surface-active derivative of saccharide and/or polysaccharide, and wherein the formed united solution containing the carbonate and the calcium chloride has a phosphorus content of below or equal to 4.2 ppm by weight with respect to calcium content.

13. The process according to claim 11, wherein said bringing together includes mixing a first solution comprising the carbonate and a second solution comprising the calcium chloride.

14. The process according to claim 7, wherein the solution containing the calcium chloride comprises mother liquor from a soda ash plant that uses the ammonia-soda process.

15. A process for producing the calcium product according to claim 5, comprising calcining a calcium carbonate product containing, in dry state, at least 97% by weight of a calcium carbonate, less than or equal to 2.8 ppm by weight of phosphorus with respect to calcium content and less than or equal to 1.4 ppm by weight of boron with respect to calcium content so as to obtain calcium oxide.

16. A method of use of the calcium product according to claim 1 in the pharmaceutical, the food and the solar cell industry.

17. A method for the production of solar cells, comprising utilizing the calcium product according to claim 5 when removing an element selected from the group consisting of boron, phosphorus, and combinations thereof, from molten silicon.

18. The process as claimed in claim 9, wherein the concentrations in carbonate and calcium chloride of said united solution containing carbonate and calcium chloride as well as the temperature at which precipitation is carried out are chosen in such a way as to favor formation of calcite crystals.

19. The process as claimed in claim 12, wherein said bringing together includes mixing a first solution comprising the carbonate and a second solution comprising the calcium chloride.

20. The process as claimed in claim 9, wherein the solution containing the calcium chloride comprises mother liquor from a soda ash plant that uses the ammonia-soda process.

21. The process as claimed in claim 11, wherein the solution containing the calcium chloride comprises mother liquor from a soda ash plant that uses the ammonia-soda process.

22. The process as claimed in claim 12, wherein the solution containing the calcium chloride comprises mother liquor from a soda ash plant that uses the ammonia-soda process.
